(19) United States
(12) Patent Application Publication
(10) Pub. No.: US 2021/0144365 A1
(43) Pub. Date: May 13, 2021

(54) METHOD AND APPARATUS OF REFERENCE SAMPLE INTERPOLATION FOR BIDIRECTIONAL INTRA PREDICTION

(71) Applicant: HUAWEI TECHNOLOGIES CO., LTD., Shenzhen (CN)

(72) Inventors: Alexey Konstantinovich FILIPPOV, Moscow (RU); Vasily Alexeevich RUFITSKIY, Moscow (RU); Jianle CHEN, Santa Clara, CA (US)

(21) Appl. No.: 17/152,341

(22) Filed: Jan. 19, 2021

Related U.S. Application Data
(63) Continuation of application No. PCT/EP2018/069849, filed on Jul. 20, 2018.

(51) Int. Cl. H04N 19/105; H04N 19/132; H04N 19/159; H04N 19/176; G06F 1/03

(52) U.S. Cl. CPC H04N 19/105; H04N 19/132; G06F 1/03; H04N 19/176; H04N 19/159

(57) ABSTRACT

Methods, apparatus, and computer-readable storage media for intra prediction of a current block of a picture are provided. In one aspect, a method includes: calculating a preliminary prediction sample value of a sample of the current block based on reference sample values of reference samples located in reconstructed neighboring blocks of the current block, and calculating a final prediction sample value of the sample by adding an increment value to the preliminary prediction sample value, the increment value being based on a position of the sample in the current block.

### CROSS-REFERENCE TO RELATED APPLICATIONS

This application is a continuation of International Application No. PCT/EP2018/069849, filed on Jul. 20, 2018. The disclosure of which is hereby incorporated by reference in its entirety.

### TECHNICAL FIELD

The present disclosure relates to the technical field of image and/or video coding and decoding, and in particular to a method and an apparatus for intra prediction.

### BACKGROUND

Digital video has been widely used since the introduction of DVD-discs. Before transmission, the video is encoded and transmitted using a transmission medium. The viewer receives the video and uses a viewing device to decode and display the video. Over the years, the quality of video has improved, for example, because of higher resolutions, color depths, and frame rates. This has lead into larger data streams that are nowadays commonly transported over internet and mobile communication networks.

Higher resolution videos, however, typically require more bandwidth as they have more information. In order to reduce bandwidth requirements, video coding standards involving compression of the video have been introduced. When the video is encoded, the bandwidth requirements (or corresponding memory requirements in case of storage) are reduced. Often this reduction comes at the cost of quality. Thus, the video coding standards try to find a balance between bandwidth requirements and quality.

The High-Efficiency Video Coding (HEVC) is an example of a video coding standard that is commonly known to persons skilled in the art. In HEVC, to split a coding unit (CU) into prediction units (PU) or transform units (TUs). The Versatile Video Coding (VVC) next-generation standard is the most recent joint video project of the ITU-T Video Coding Experts Group (VCEG) and the ISO/IEC Moving Picture Experts Group (MPEG) standardization organizations, working together in a partnership known as the Joint Video Exploration Team (JVET). VVC is also referred to as ITU-T H.266/VVC (Versatile Video Coding) standard. In VVC, it removes the concepts of multiple partition types, i.e., it removes the separation of the CU, PU, and TU concepts except as needed for CUs that have a size too large for the maximum transform length, and supports more flexibility for CU partition shapes.

Processing of these coding units (CUs) (also referred to as blocks) depends on their size, spatial position, and a coding mode specified by an encoder. Coding modes can be classified into two groups according to the type of prediction: intra- and inter-prediction modes. Intra prediction modes use samples of the same picture (also referred to as frame or image) to generate reference samples to calculate the prediction values for the samples of the block being reconstructed. Intra prediction is also referred to as spatial prediction. Inter-prediction modes are designed for temporal prediction and uses reference samples of previous or next pictures to predict samples of the block of the current picture.

The bidirectional intra prediction (BIP) is a kind of intra-prediction. The calculation procedure for BIP is complicated, which leads to lower coding efficiency.

### SUMMARY

The present disclosure aims to overcome the above problem and to provide an apparatus for intra prediction with a reduced complexity of calculations and an improved coding efficiency, and a respective method.

This is achieved by the features of the independent claims.

According to a first aspect of the present invention, an apparatus for intra prediction of a current block of a picture is provided. The apparatus includes processing circuitry configured to calculate a preliminary prediction sample value of a sample of the current block on the basis of reference sample values of reference samples located in reconstructed neighboring blocks of the current block. The processing circuitry is further configured to calculate a final prediction sample value of the sample by adding an increment value to the preliminary prediction sample value, wherein the increment value depends on the position of the sample in the current block.

According to a second aspect of the present invention, a method for intra prediction of a current block of a picture is provided. The method includes the steps of calculating a preliminary prediction sample value of a sample of the current block on the basis of reference sample values of reference samples located in reconstructed neighboring blocks of the current block and of calculating a prediction sample value of the sample by adding an increment value to the preliminary prediction sample value, wherein the increment value depends on the position of the sample in the current block.

In the present disclosure, the term “sample” is used as a synonym to “pixel”. In particular, a “sample value” means any value characterizing a pixel, such as a luma or chroma value.

A “picture” in the present disclosure means any kind of image picture, and applies, in particular, to a frame of a video signal. However, the present disclosure is not limited to video encoding and decoding but is applicable to any kind of image processing using intra-prediction. It is the particular approach of the present invention to calculate the prediction on the basis of reference samples in neighboring blocks that are already reconstructed, i.e., so-called “primary” reference samples, without the need of generating further “secondary” reference samples in blocks that are currently unavailable by interpolation. According to an embodiment of the present disclosure, a preliminary sample value is improved by adding an increment value that is determined depending on the position of the sample in the current block. This calculation is performed by way of incremental edition only and avoids the use of resource-consuming multiplication operations, which improves coding efficiency.

In accordance with embodiments, the reference samples located in a row of samples directly above the current block and in a column of samples to the left or the right of the current block. Alternatively, they are located in a row of samples directly below the current block and in a column of samples to the left or to the right of the current block.

In accordance with embodiments, the preliminary prediction sample value is calculated according to directional intra-prediction of the sample of the current block.

In accordance with embodiments, the increment value is determined by further taking into account a number of samples of the current block in width, and a number of samples of the current block are in height.

In accordance with embodiments, the increment value is determined by using two reference samples. In accordance with specific embodiments, one of them is located in the column that is a right neighbor of the rightmost column of the current block, for example, the top right neighbor sample, and another one is located in the row that is a below neighbor of the lowest row of the current block, for example, the bottom left neighbor sample.

In other embodiments, one of them may be located in the column that is a left neighbor of the leftmost column of the current block, for example, the top-left neighbor sample, and another one is located in the row that is a below neighbor of the lowest row of the current block, for example, the bottom right neighbor sample.

In the same embodiments, the increment value is determined by using three or more reference samples.

In accordance with alternative embodiments, the increment value is determined using a look-up-table the values of which specify a partial increment or increment step size of the increment value depending on the intra prediction mode index, wherein, for example, the lookup table provides for each intra prediction mode index a partial increment or increment step size of the increment value. In an embodiment of the present disclosure, the partial increment or increment step size of the increment value means a difference between increment values for two horizontally adjacent samples or two vertically adjacent samples.

In accordance with embodiments, the increment value depends linearly on the position within a row of predicted samples in the current block. A particular example thereof is described below with reference to FIG. 10.

In accordance with alternative embodiments, the increment value depends piecewise linearly on the position within a row of predicted samples and the current block. A particular example of such an embodiment is described below with reference to FIG. 11.

In accordance with embodiments, a directional mode is used for calculating the preliminary prediction sample value on the basis of directional intra prediction. This includes horizontal and vertical directions, as well as all directions that are inclined with respect to horizontal and vertical, but does not include DC and planar modes.

In accordance with embodiments, the increment value is determined by further taking into account the block shape and/or the prediction direction.

In particular, in accordance with embodiments, the current block is split by at least one skew line to obtain at least two regions of the block and to determine the increment value differently for different regions. More specifically, the skew line has a slope corresponding to an intra-prediction mode that is used. Since a “skew line” is understood so as to be inclined with reference to horizontal and vertical directions, in such embodiments, the intra-prediction mode is neither vertical nor horizontal (and, of course, also neither planar nor DC).

In accordance with further specific embodiments, the current block is split by two parallel skew lines crossing opposite corners of the current block. Thereby, three regions are obtained. This is, the block is split into two triangular regions and a parallelogram region in-between.

In alternative specific embodiments, using only a single skew line for splitting the current block, two trapezoidal regions are generated.

In accordance with embodiments, the increment value linearly depends on the distance of the sample from a block boundary in the vertical direction and linearly depends on the distance of the sample from a block boundary in the horizontal direction. In other words, the difference between the increments applied to two samples (pixels) that are adjacent along a parallel to the block boundaries (i.e., in the “row (x)” or “column (y)” direction) is the same.

In accordance with embodiments, the adding of the increment value is performed in an iterative procedure, wherein partial increments are subsequently added to the preliminary prediction. In particular, said partial increments represent the differences between the increments applied to horizontally or vertically adjacent samples, as introduced in the foregoing paragraph.

In accordance with embodiments, the prediction of the sample value is calculated using reference sample values only from reference samples located in reconstructed neighboring (so-called “primary samples”) blocks. This means, that no samples (so-called “secondary samples”) are used that are generated by means of interpolation using primary reference samples. This includes both the calculation of the preliminary prediction and the calculation of the final prediction sample value.

In accordance with a third aspect of the present invention, an encoding apparatus for encoding a current block of a picture is provided. The encoding apparatus comprises an apparatus for intra-prediction according to the first aspect for providing a predicted block for the current block and processing circuitry configured to encode the current block on the basis of the predicted block.

The processing circuitry can, in particular, be the same processing circuitry as used according to the first aspect, but can also be another, specifically dedicated processing circuitry.

In accordance with a fourth aspect of the present invention, a decoding apparatus for decoding the current encoded block of a picture is provided. The decoding apparatus comprises an apparatus for intra-prediction according to the first aspect of the present invention for providing the predicted block for the encoded block and processing circuitry configured to restore the current block on the basis of the encoded block and the predicted block.

The processing circuitry can, in particular, be the same as according to the first aspect, but it can also be a separate processing circuitry.

In accordance with a fifth aspect of the present invention, a method of encoding a current block of a picture is provided. The method comprises the steps of providing a predicted block for the current block by performing the method according to the second aspect for the samples of the current block and of encoding the current block on the basis of the predicted block.

In accordance with a sixth aspect of the present invention, a method of decoding the current encoded block of a picture is provided. The method comprises the steps of providing a predicted block for the encoded block by performing the method according to the second aspect of the invention for the samples of the current block and of restoring the current block on the basis of the encoded block and the predicted block.

In accordance with a seventh aspect of the present invention, a computer-readable medium storing instructions, which when executed on a processor cause the processor to perform all steps of a method according to the second, fifth, or sixth aspects of the invention.

Further advantages and embodiments of the invention are the subject matter of dependent claims and described in the below description.

### BRIEF DESCRIPTION OF DRAWINGS

The following embodiments are described in more detail with reference to the attached figures and drawings, in which:

FIG. 1 is a block diagram showing an example of a video coding system configured to implement embodiments of the invention.

FIG. 2 is a block diagram showing an example of a video encoder configured to implement embodiments of the invention.

FIG. 3 is a block diagram showing an example structure of a video decoder configured to implement embodiments of the invention.

FIG. 4 illustrates an example of the process of obtaining predicted sample values using a distance-weighting procedure.

FIG. 5 shows an example of vertical intra prediction.

FIG. 6 shows an example of skew-directional intra prediction.

FIG. 7 is an illustration of the dependence of a weighting coefficient on the column index for a given row.

FIG. 8 is an illustration of weights are defined for sample positions within an 8×32 block in case of diabolical intra prediction.

FIG. 9A is a data flow chart of an intra prediction process in accordance with embodiments of the present invention.

FIG. 9B is a data flow chart of an intra prediction process in accordance with alternative embodiments of the present invention.

FIG. 10 is a flowchart illustrating the processing for derivation of prediction samples in accordance with embodiments of the present invention.

FIG. 11 is a flowchart illustrating the processing for derivation of prediction samples in accordance with further embodiments of the present invention.

### DETAILED DESCRIPTION OF EMBODIMENTS

### General Considerations

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g., functional units, to perform the described one or plurality of method steps (e.g., one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g., functional units, a corresponding method may include one step to perform the functionality of the one or plurality of units (e.g., one step performing the functionality of the one or plurality of units, or a plurality of steps each performing the functionality of one or more of the plurality of units), even if such one or plurality of steps are not explicitly described or illustrated in the figures. Further, it is understood that the features of the various embodiments and/or aspects described herein may be combined with each other, unless specifically noted otherwise.

Video coding typically refers to the processing of a sequence of pictures, which form the video or video sequence. Instead of the term picture, the terms frame or image may be used as synonyms in the field of video coding. Video coding comprises two parts, video encoding, and video decoding. Video encoding is performed at the source side, typically comprising processing (e.g., by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general, as will be explained later) shall be understood to relate to both “encoding” and “decoding” of video pictures. The combination of the encoding part and the decoding part is also referred to as CODEC (COding and DECoding).

In case of lossless video coding, the original video pictures can be reconstructed, i.e., the reconstructed video pictures have the same quality as the original video pictures (assuming no transmission loss or other data loss during storage or transmission). In case of lossy video coding, further compression, e.g., by quantization, is performed to reduce the amount of data representing the video pictures, which cannot be reconstructed at the decoder, i.e., the quality of the reconstructed video pictures is lower or worse compared to the quality of the original video pictures.

Several video coding standards since H.261 belong to the group of “lossy hybrid video codecs” (i.e., combine spatial and temporal prediction in the sample domain and 2D transform coding for applying quantization in the transform domain). Each picture of a video sequence is typically partitioned into a set of non-overlapping blocks, and the coding is typically performed on a block level. In other words, at the encoder, the video is typically processed, i.e., encoded, on a block (video block) level, e.g., by using spatial (intra picture) prediction and temporal (inter-picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g., intra- and inter predictions) and/or reconstructions for processing, i.e., coding the subsequent blocks.

As video picture processing (also referred to as moving picture processing) and still picture processing (the term processing comprising coding), share many concepts and technologies or tools, in the following the term “picture” or “image” and equivalent the term “picture data” or “image data” is used to refer to a video picture of a video sequence (as explained above) and/or to a still picture to avoid unnecessary repetitions and distinctions between video pictures and still pictures, where not necessary. In case the description refers to still pictures (or still images) only, the term “still picture” shall be used.

In the following embodiments of an encoder 100, a decoder 200, and a coding system 300 are described based on FIGS. 1 to 3.

FIG. 1 is a conceptual or schematic block diagram illustrating an embodiment of a coding system 300, e.g., a picture coding system 300, wherein the coding system 300 comprises a source device 310 configured to provide encoded data 330, e.g., an encoded picture 330, e.g., to a destination device 320 for decoding the encoded data 330.

The source device 310 comprises an encoder 100 or encoding unit 100, and may additionally, i.e., optionally, comprise a picture source 312, a pre-processing unit 314, e.g., a picture pre-processing unit 314, and a communication interface or communication unit 318.

The picture source 312 may comprise or be any kind of picture capturing device, for example, for capturing a real-world picture, and/or any kind of a picture generating device, for example, a computer-graphics processor for generating a computer-animated picture, or any kind of device for obtaining and/or providing a real-world picture, a computer-animated picture (e.g., a screen content, a virtual reality (VR) picture) and/or any combination thereof (e.g., an augmented reality (AR) picture). In the following, all these kinds of pictures or images and any other kind of picture or image will be referred to as “picture” “image” or “picture data” or “image data”, unless specifically described otherwise, while the previous explanations with regard to the terms “picture” or “image” covering “video pictures” and “still pictures” still hold true, unless explicitly specified differently.

A (digital) picture is or can be regarded as a two-dimensional array or matrix of samples with intensity values. A sample in the array may also be referred to as a pixel (short form of picture element) or a pel. The number of samples in a horizontal and vertical direction (or axis) of the array or picture defines the size and/or resolution of the picture. For representation of color, typically, three color components are employed, i.e., the picture may be represented or include three sample arrays. In RGB (red-green-blue) format or color space, a picture comprises a corresponding red, green, and blue sample array. However, in video coding, each pixel is typically represented in a luminance/chrominance format or color space, e.g., YCbCr, which comprises a luminance component indicated by Y (sometimes also L is used instead) and two chrominance components indicated by Cb and Cr. The luminance (or short luma) component Y represents the brightness or grey level intensity (e.g., like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array.

The picture source 312 may be, for example, a camera for capturing a picture, a memory, e.g., a picture memory, comprising or storing a previously captured or generated picture, and/or any kind of interface (internal or external) to obtain or receive a picture. The camera may be, for example, a local or integrated camera integrated in the source device, the memory may be a local or integrated memory, e.g., integrated in the source device. The interface may be, for example, an external interface to receive a picture from an external video source, for example, an external picture capturing device like a camera, an external memory, or an external picture generating device, for example, an external computer-graphics processor, computer or server. The interface can be any kind of interface, e.g., a wired or wireless interface, an optical interface, according to any proprietary or standardized interface protocol. The interface for obtaining the picture data 313 may be the same interface as or a part of the communication interface 318.

Interfaces between units within each device include cable connections, USB interfaces, Communication interfaces 318 and 322 between the source device 310 and the destination device 320 include cable connections, USB interfaces, radio interfaces.

In distinction to the pre-processing unit 314 and the processing performed by the pre-processing unit 314, the picture or picture data 313 may also be referred to as raw picture or raw picture data 313.

Pre-processing unit 314 is configured to receive the (raw) picture data 313 and to perform pre-processing on the picture data 313 to obtain a pre-processed picture 315 or pre-processed picture data 315. Pre-processing performed by the pre-processing unit 314 may, e.g., comprise trimming, color format conversion (e.g., from RGB to YCbCr), color correction, or de-noising.

The encoder 100 is configured to receive the pre-processed picture data 315 and provide encoded picture data 171 (further details will be described, e.g., based on FIG. 2).

Communication interface 318 of the source device 310 may be configured to receive the encoded picture data 171 and to directly transmit it to another device, e.g., the destination device 320 or any other device, for storage or direct re-construction, or to process the encoded picture data 171 for respectively before storing the encoded data 330 and/or transmitting the encoded data 330 to another device, e.g., the destination device 320 or any other device for decoding or storing.

The destination device 320 comprises a decoder 200 or decoding unit 200, and may additionally, i.e., optionally, comprise a communication interface or communication unit 322, a post-processing unit 326, and a display device 328.

The communication interface 322 of the destination device 320 is configured to receive the encoded picture data 171 or the encoded data 330, e.g., directly from the source device 310 or from any other source, e.g., a memory, e.g., an encoded picture data memory.

The communication interface 318 and the communication interface 322 may be configured to transmit respectively receive the encoded picture data 171 or encoded data 330 via a direct communication link between the source device 310 and the destination device 320, e.g., a direct wired or wireless connection, including optical connection or via any kind of network, e.g., a wired or wireless network or any combination thereof, or any kind of private and public network, or any kind of combination thereof.

The communication interface 318 may be, e.g., configured to package the encoded picture data 171 into an appropriate format, e.g., packets, for transmission over a communication link or communication network, and may further comprise data loss protection.

The communication interface 322, forming the counterpart of the communication interface 318, may be, e.g., configured to de-package the encoded data 330 to obtain the encoded picture data 171 and may further be configured to perform data loss protection and data loss recovery, e.g., comprising error concealment.

Both communication interface 318 and communication interface 322 may be configured as unidirectional communication interfaces as indicated by the arrow for the encoded picture data 330 in FIG. 1 pointing from the source device 310 to the destination device 320, or bi-directional communication interfaces, and may be configured, e.g., to send and receive messages, e.g., to set up a connection, to acknowledge and/or re-send lost or delayed data including picture data, and exchange any other information related to the communication link and/or data transmission, e.g., encoded picture data transmission.

The decoder 200 is configured to receive the encoded picture data 171 and provide decoded picture data 231 or a decoded picture 231.

The post-processor 326 of destination device 320 is configured to post-process the decoded picture data 231, e.g., the decoded picture 231, to obtain post-processed picture data 327, e.g., a post-processed picture 327. The post-processing performed by the post-processing unit 326 may comprise, e.g., color format conversion (e.g., from YCbCr to RGB), color correction, trimming, or re-sampling, or any other processing, e.g., for preparing the decoded picture data 231 for display, e.g., by display device 328.

The display device 328 of the destination device 320 is configured to receive the post-processed picture data 327 for displaying the picture, e.g., to a user or viewer. The display device 328 may be or comprise any kind of display for representing the reconstructed picture, e.g., an integrated or external display or monitor. The displays may, e.g., comprise cathode ray tubes (CRT), liquid crystal displays (LCD), plasma displays, organic light-emitting diodes (OLED) displays, or any kind of other display, such as projectors, holographic displays, apparatuses to generate holograms.

Although FIG. 1 depicts the source device 310 and the destination device 320 as separate devices, embodiments of devices may also comprise both or both functionalities, the source device 310 or corresponding functionality, and the destination device 320 or corresponding functionality. In such embodiments, the source device 310 or corresponding functionality and the destination device 320 or corresponding functionality may be implemented using the same hardware and/or software or by separate hardware and/or software or any combination thereof.

As will be apparent for the skilled person based on the description, the existence and (exact) split of functionalities of the different units or functionalities within the source device 310 and/or destination device 320, as shown in FIG. 1, may vary depending on the actual device and application.

In the following, a few non-limiting examples for the coding system 300, the source device 310, and/or destination device 320 will be provided.

Various electronic products, such as a smartphone, a tablet, or a handheld camera with integrated display, may be seen as examples for a coding system 300. They contain a display device 328, and most of them contain an integrated camera, i.e., a picture source 312, as well. Picture data taken by the integrated camera is processed and displayed. The processing may include encoding and decoding of the picture data internally. In addition, the encoded picture data may be stored in an integrated memory.

Alternatively, these electronic products may have wired or wireless interfaces to receive picture data from external sources, such as the internet or external cameras, or to transmit the encoded picture data to external displays or storage units.

On the other hand, set-top boxes do not contain an integrated camera or a display but perform picture processing of received picture data for display on an external display device. Such a set-top box may be embodied by a chipset, for example.

Alternatively, a device similar to a set-top box may be included in a display device, such as a TV set with an integrated display.

Surveillance cameras without an integrated display constitute a further example. They represent a source device with an interface for the transmission of the captured and encoded picture data to an external display device or an external storage device.

Contrary, devices such as smart glasses or 3D glasses, for instance, used for AR or VR, represent a destination device 320. They receive the encoded picture data and display them. Therefore, the source device 310 and the destination device 320, as shown in FIG. 1, are just example embodiments of the invention, and embodiments of the invention are not limited to those shown in FIG. 1.

Source device 310 and destination device 320 may comprise any of a wide range of devices, including any kind of handheld or stationary devices, e.g., notebook or laptop computers, mobile phones, smartphones, tablets or tablet computers, cameras, desktop computers, set-top boxes, televisions, display devices, digital media players, video gaming consoles, video streaming devices, broadcast receiver device, or the like. For large-scale professional encoding and decoding, the source device 310 and/or the destination device 320 may additionally comprise servers and work stations, which may be included in large networks. These devices may use no or any kind of operating system.

### Encoder & Encoding Method

FIG. 2 shows a schematic/conceptual block diagram of an embodiment of an encoder 100, e.g., a picture encoder 100, which comprises an input 102, a residual calculation unit 104, a transformation unit 106, a quantization unit 108, an inverse quantization unit 110, and inverse transformation unit 112, a re-construction unit 114, a buffer 116, a loop filter 120, a decoded picture buffer (DPB) 130, a prediction unit 160, which includes an inter estimation unit 142, an inter prediction unit 144, an intra-estimation unit 152, an intra-prediction unit 154 and a mode selection unit 162, an entropy encoding unit 170, and an output 172. A video encoder 100, as shown in FIG. 8, may also be referred to as a hybrid video encoder or a video encoder according to a hybrid video codec. Each unit may consist of a processor and a non-transitory memory to perform its processing steps by executing a code stored in the non-transitory memory by the processor.

For example, the residual calculation unit 104, the transformation unit 106, the quantization unit 108, and the entropy encoding unit 170 form a forward signal path of the encoder 100, whereas, for example, the inverse quantization unit 110, the inverse transformation unit 112, the re-construction unit 114, the buffer 116, the loop filter 120, the decoded picture buffer (DPB) 130, the inter prediction unit 144, and the intra-prediction unit 154 form a backward signal path of the encoder, wherein the backward signal path of the encoder corresponds to the signal path of the decoder to provide inverse processing for identical re-construction and prediction (see decoder 200 in FIG. 3).

The encoder is configured to receive, e.g., by input 102, a picture 101 or a picture block 103 of the picture 101, e.g., picture of a sequence of pictures forming a video or video sequence. The picture block 103 may also be referred to as current picture block or picture block to be coded, and the picture 101 as current picture or picture to be coded (in particular in video coding to distinguish the current picture from other pictures, e.g., previously encoded and/or decoded pictures of the same video sequence, i.e., the video sequence which also comprises the current picture).

### Partitioning

Embodiments of the encoder 100 may comprise a partitioning unit (not depicted in FIG. 2), e.g., which may also be referred to as picture partitioning unit, configured to partition the picture 103 into a plurality of blocks, e.g., blocks like block 103, typically into a plurality of non-overlapping blocks. The partitioning unit may be configured to use the same block size for all pictures of a video sequence and the corresponding grid defining the block size, or to change the block size between pictures or subsets or groups of pictures, and partition each picture into the corresponding blocks.

Each block of the plurality of blocks may have square dimensions or more general rectangular dimensions. Blocks being picture areas with non-rectangular shapes may not appear.

Like the picture 101, the block 103 again is or can be regarded as a two-dimensional array or matrix of samples with intensity values (sample values), although of smaller dimension than the picture 101. In other words, the block 103 may comprise, e.g., one sample array (e.g., a luma array in case of a monochrome picture 101) or three sample arrays (e.g., a luma and two chroma arrays in case of a color picture 101) or any other number and/or kind of arrays depending on the color format applied. The number of samples in a horizontal and vertical direction (or axis) of the block 103 define the size of block 103.

Encoder 100, as shown in FIG. 2, is configured to encode the picture 101 block by block, e.g., the encoding and prediction is performed per block 103.

### Residual Calculation

The residual calculation unit 104 is configured to calculate a residual block 105 based on the picture block 103 and a prediction block 165 (further details about the prediction block 165 are provided later), e.g., by subtracting sample values of the prediction block 165 from sample values of the picture block 103, sample by sample (pixel by pixel) to obtain the residual block 105 in the sample domain.

### Transformation

The transformation unit 106 is configured to apply a transformation. e.g., a spatial frequency transform or a linear spatial transform, e.g., a discrete cosine transform (DCT) or discrete sine transform(DST), on the sample values of the residual block 105 to obtain transformed coefficients 107 in a transform domain. The transformed coefficients 107 may also be referred to as transformed residual coefficients and represent the residual block 105 in the transform domain.

The transformation unit 106 may be configured to apply integer approximations of DCT/DST, such as the core transforms specified for HEVC/H.265. Compared to an orthonormal DCT transform, such integer approximations are typically scaled by a certain factor. In order to preserve the norm of the residual block, which is processed by forward and inverse transforms, additional scaling factors are applied as part of the transform process. The scaling factors are typically chosen based on certain constraints like scaling factors being a power of two for shift operation, bit depth of the transformed coefficients, a trade-off between accuracy and implementation costs, etc. Specific scaling factors are, for example, specified for the inverse transform, e.g., by inverse transformation unit 212, at a decoder 20 (and the corresponding inverse transform. e.g., by inverse transformation unit 112 at an encoder 100) and corresponding scaling factors for the forward transform, e.g., by transformation unit 106, at an encoder 100 may be specified accordingly.

### Quantization

The quantization unit 108 is configured to quantize the transformed coefficients 107 to obtain quantized coefficients 109, e.g., by applying scalar quantization or vector quantization. The quantized coefficients 109 may also be referred to as quantized residual coefficients 109. For example, for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may, for example, be an index to a predefined set of applicable quantization step sizes. For example, small quantization parameters may correspond to fine quantization (small quantization step sizes), and large quantization parameters may correspond to coarse quantization (large quantization step sizes) or vice versa. The quantization may include division by a quantization step size, and corresponding or inverse dequantization, e.g., by inverse quantization 110, may include multiplication by the quantization step size. Embodiments, according to HEVC (High-Efficiency Video Coding), may be configured to use a quantization parameter to determine the quantization step size. Generally, the quantization step size may be calculated based on a quantization parameter using a fixed-point approximation of an equation, including division. Additional scaling factors may be introduced for quantization and dequantization to restore the norm of the residual block, which might get modified because of the scaling used in the fixed-point approximation of the equation for quantization step size and quantization parameter. In one example implementation, the scaling of the inverse transform and dequantization might be combined. Alternatively, customized quantization tables may be used and signaled from an encoder to a decoder, e.g., in a bitstream. The quantization is a lossy operation, wherein the loss increases with increasing quantization step sizes.

Embodiments of the encoder 100 (or respectively of the quantization unit 108) may be configured to output the quantization settings, including quantization scheme and quantization step size, e.g., by means of the corresponding quantization parameter, so that a decoder 200 may receive and apply the corresponding inverse quantization. Embodiments of the encoder 100 (or quantization unit 108) may be configured to output the quantization scheme and quantization step size, e.g., directly or entropy encoded via the entropy encoding unit 170 or any other entropy coding unit.

The inverse quantization unit 110 is configured to apply the inverse quantization of the quantization unit 108 on the quantized coefficients to obtain dequantized coefficients 111, e.g., by applying the inverse of the quantization scheme applied by the quantization unit 108 based on or using the same quantization step size as the quantization unit 108. The dequantized coefficients 111 may also be referred to as dequantized residual coefficients 111 and correspond—although typically not identical to the transformed coefficients due to the loss by quantization—to the transformed coefficients 108.

The inverse transformation unit 112 is configured to apply the inverse transformation of the transformation applied by the transformation unit 106, e.g., an inverse discrete cosine transform (DCT) or inverse discrete sine transform (DST), to obtain an inverse transformed block 113 in the sample domain. The inverse transformed block 113 may also be referred to as inverse transformed dequantized block 113 or inverse transformed residual block 113.

The re-construction unit 114 is configured to combine the inverse transformed block 113 and the prediction block 165 to obtain a reconstructed block 115 in the sample domain, e.g., by sample wise adding the sample values of the decoded residual block 113 and the sample values of the prediction block 165.

The buffer unit 116 (or short “buffer” 116), e.g., a line buffer 116, is configured to buffer or store the reconstructed block and the respective sample values, for example, for intra estimation and/or intra prediction. In further embodiments, the encoder may be configured to use unfiltered reconstructed blocks and/or the respective sample values stored in buffer unit 116 for any kind of estimation and/or prediction.

Embodiments of the encoder 100 may be configured such that, e.g., the buffer unit 116 is not only used for storing the reconstructed blocks 115 for intra estimation 152 and/or intra prediction 154 but also for the loop filter unit 120, and/or such that, e.g., the buffer unit 116 and the decoded picture buffer unit 130 form one buffer. Further embodiments may be configured to use filtered blocks 121 and/or blocks or samples from the decoded picture buffer 130 (both not shown in FIG. 2) as input or basis for intra estimation 152 and/or intra prediction 154.

The loop filter unit 120 (or short “loop filter” 120) is configured to filter the reconstructed block 115 to obtain a filtered block 121, e.g., by applying a de-blocking sample-adaptive offset (SAO) filter or other filters, e.g., sharpening or smoothing filters or collaborative filters. The filtered block 121 may also be referred to as filtered reconstructed block 121.

Embodiments of the loop filter unit 120 may comprise a filter analysis unit and the actual filter unit, wherein the filter analysis unit is configured to determine loop filter parameters for the actual filter. The filter analysis unit may be configured to apply fixed pre-determined filter parameters to the actual loop filter, adaptively select filter parameters from a set of pre-determined filter parameters, or adaptively calculate filter parameters for the actual loop filter.

Embodiments of the loop filter unit 120 may comprise (not shown in FIG. 2) one or a plurality of filters (such as loop filter components and/or sub-filters), e.g., one or more of different kinds or types of filters, e.g., connected in series or in parallel or in any combination thereof, wherein each of the filters may comprise individually or jointly with other filters of the plurality of filters a filter analysis unit to determine the respective loop filter parameters, e.g., as described in the previous paragraph.

Embodiments of the encoder 100 (respectively loop filter unit 120) may be configured to output the loop filter parameters, e.g., directly or entropy encoded via the entropy encoding unit 170 or any other entropy coding unit, so that, e.g., a decoder 200 may receive and apply the same loop filter parameters for decoding.

The decoded picture buffer (DPB) 130 is configured to receive and store the filtered block 121. The decoded picture buffer 130 may be further configured to store other previously filtered blocks, e.g., previously reconstructed and filtered blocks 121, of the same current picture or of different pictures. e.g., previously reconstructed pictures, and may provide complete previously reconstructed, i.e., decoded, pictures (and corresponding reference blocks and samples) and/or a partially reconstructed current picture (and corresponding reference blocks and samples), for example for inter estimation and/or inter prediction.

Further embodiments of the invention may also be configured to use the previously filtered blocks and corresponding filtered sample values of the decoded picture buffer 130 for any kind of estimation or prediction. e.g., intra estimation and prediction as well as inter estimation and prediction.

The prediction unit 160, also referred to as block prediction unit 160, is configured to receive or obtain the picture block 103 (current picture block 103 of the current picture 101) and decoded or at least reconstructed picture data. e.g., reference samples of the same (current) picture from buffer 116 and/or decoded picture data 231 from one or a plurality of previously decoded pictures from decoded picture buffer 130, and to process such data for prediction, i.e., to provide a prediction block 165, which may be an inter-predicted block 145 or an intra-predicted block 155.

Mode selection unit 162 may be configured to select a prediction mode (e.g., an intra or inter prediction mode) and/or a corresponding prediction block 145 or 155 to be used as prediction block 165 for the calculation of the residual block 105 and for the re-construction of the reconstructed block 115.

Embodiments of the mode selection unit 162 may be configured to select the prediction mode (e.g., from those supported by prediction unit 160), which provides the best match or, in other words, the minimum residual (minimum residual means better compression for transmission or storage), or a minimum signaling overhead (minimum signaling overhead means better compression for transmission or storage), or which considers or balances both. The mode selection unit 162 may be configured to determine the prediction mode based on rate-distortion optimization (RDO), i.e., select the prediction mode which provides a minimum rate-distortion optimization or which associated rate-distortion at least fulfills a prediction mode selection criterion.

In the following, the prediction processing (e.g., prediction unit 160) and mode selection (e.g., by mode selection unit 162) performed by an example encoder 100 will be explained in more detail.

As described above, encoder 100 is configured to determine or select the best or an optimum prediction mode from a set of (pre-determined) prediction modes. The set of prediction modes may comprise, e.g., intra-prediction modes and/or inter-prediction modes.

The set of intra-prediction modes may comprise 32 different intra-prediction modes, e.g., non-directional modes like DC (or mean) mode and planar mode, or directional modes, e.g., as defined in H.264, or may comprise 65 different intra-prediction modes, e.g., non-directional modes like DC (or mean) mode and planar mode, or directional modes, e.g., as defined in H.265.

The set of (or possible) inter-prediction modes depend on the available reference pictures (i.e., previous at least partially decoded pictures, e.g., stored in DPB 230) and other inter-prediction parameters, e.g., whether the whole reference picture or only a part, e.g., a search window area around the area of the current block, of the reference picture, is used for searching for a best matching reference block, and/or, e.g., whether pixel interpolation is applied, e.g., half/semi-pel and/or quarter-pel interpolation, or not.

Additional to the above prediction modes, skip mode and/or direct mode may be applied.

The prediction unit 160 may be further configured to partition the block 103 into smaller block partitions or sub-blocks, e.g. iteratively using quad-tree-partitioning (QT), binary partitioning (BT) or triple-tree-partitioning (TT) or any combination thereof, and to perform, e.g. the prediction for each of the block partitions or sub-blocks, wherein the mode selection comprises the selection of the tree-structure of the partitioned block 103 and the prediction modes applied to each of the block partitions or sub-blocks.

The inter estimation unit 142, also referred to as inter-picture estimation unit 142, is configured to receive or obtain the picture block 103 (current picture block 103 of the current picture 101) and a decoded picture 231, or at least one or a plurality of previously reconstructed blocks, e.g., reconstructed blocks of one or a plurality of other/different previously decoded pictures 231, for inter estimation (or “inter-picture estimation”). E.g., a video sequence may comprise the current picture and the previously decoded pictures 231, or in other words, the current picture and the previously decoded pictures 231 may be part of or form a sequence of pictures forming a video sequence.

The encoder 100 may, e.g., be configured to select (obtain/determine) a reference block from a plurality of reference blocks of the same or different pictures of the plurality of other pictures and provide a reference picture (or reference picture index, . . . ) and/or an offset (spatial offset) between the position (x, y coordinates) of the reference block and the position of the current block as inter estimation parameters 143 to the inter prediction unit 144. This offset is also called motion vector (MV). The inter estimation is also referred to as motion estimation (ME), and the inter prediction also motion prediction (MP).

The inter prediction unit 144 is configured to obtain. e.g., receive, an inter prediction parameter 143 and to perform inter prediction based on or using the inter prediction parameter 143 to obtain an inter prediction block 145.

Although FIG. 2 shows two distinct units (or steps) for the inter-coding, namely inter estimation 142 and inter prediction 152, both functionalities may be performed as one (inter estimation typically requires/comprises calculating an/the inter prediction block, i.e., the or a “kind of” inter prediction 154), e.g., by testing all possible or a pre-determined subset of possible inter prediction modes iteratively while storing the currently best inter prediction mode and respective inter prediction block, and using the currently best inter prediction mode and respective inter prediction block as the (final) inter prediction parameter 143 and inter prediction block 145 without performing another time the inter prediction 144.

The intra estimation unit 152 is configured to obtain, e.g., receive, the picture block 103 (current picture block) and one or a plurality of previously reconstructed blocks, e.g., reconstructed neighbor blocks, of the same picture for intra estimation. The encoder 100 may, e.g., be configured to select (obtain/determine) an intra prediction mode from a plurality of intra prediction modes and provide it as intra estimation parameter 153 to the intra prediction unit 154.

Embodiments of the encoder 100 may be configured to select the intra-prediction mode based on an optimization criterion, e.g., minimum residual (e.g., the intra-prediction mode providing the prediction block 155 most similar to the current picture block 103) or minimum rate-distortion.

The intra prediction unit 154 is configured to determine based on the intra prediction parameter 153, e.g., the selected intra prediction mode 153, the intra prediction block 155.

Although FIG. 2 shows two distinct units (or steps) for the intra-coding, namely intra estimation 152 and intra prediction 154, both functionalities may be performed as one (intra estimation typically requires/comprises calculating the intra prediction block, i.e., the or a “kind of” intra prediction 154), e.g., by testing all possible or a pre-determined subset of possible intra-prediction modes iteratively while storing the currently best intra prediction mode and respective intra prediction block, and using the currently best intra prediction mode and respective intra prediction block as the (final) intra prediction parameter 153 and intra prediction block 155 without performing another time the intra prediction 154.

The entropy encoding unit 170 is configured to apply an entropy encoding algorithm or scheme (e.g., a variable-length coding (VLC) scheme, a context-adaptive VLC scheme (CALVC), an arithmetic coding scheme, a context adaptive binary arithmetic coding (CABAC)) on the quantized residual coefficients 109, inter-prediction parameters 143, intra prediction parameter 153, and/or loop filter parameters, individually or jointly (or not at all) to obtain encoded picture data 171 which can be output by the output 172, e.g., in the form of an encoded bitstream 171.

### Decoder

FIG. 3 shows an exemplary video decoder 200 configured to receive encoded picture data (e.g., encoded bitstream) 171, e.g., encoded by encoder 100, to obtain a decoded picture 231.

The decoder 200 comprises an input 202, an entropy decoding unit 204, an inverse quantization unit 210, an inverse transformation unit 212, a re-construction unit 214, a buffer 216, a loop filter 220, a decoded picture buffer 230, a prediction unit 260, which includes an inter prediction unit 244, an intra prediction unit 254, and a mode selection unit 260, and an output 232.

The entropy decoding unit 204 is configured to perform entropy decoding to the encoded picture data 171 to obtain, e.g., quantized coefficients 209 and/or decoded coding parameters (not shown in FIG. 3), e.g. (decoded) any or all of inter-prediction parameters 143, intra prediction parameter 153, and/or loop filter parameters.

In embodiments of the decoder 200, the inverse quantization unit 210, the inverse transformation unit 212, the re-construction unit 214, the buffer 216, the loop filter 220, the decoded picture buffer 230, the prediction unit 260, and the mode selection unit 260 are configured to perform the inverse processing of the encoder 100 (and the respective functional units) to decode the encoded picture data 171.

In particular, the inverse quantization unit 210 may be identical in function to the inverse quantization unit 110, the inverse transformation unit 212 may be identical in function to the inverse transformation unit 112, the re-construction unit 214 may be identical in function re-construction unit 114, the buffer 216 may be identical in function to the buffer 116, the loop filter 220 may be identical in function to the loop filter 220 (with regard to the actual loop filter as the loop filter 220 typically does not comprise a filter analysis unit to determine the filter parameters based on the original image 101 or block 103 but receives (explicitly or implicitly) or obtains the filter parameters used for encoding, e.g., from entropy decoding unit 204), and the decoded picture buffer 230 may be identical in function to the decoded picture buffer 130.

The prediction unit 260 may comprise an inter prediction unit 244 and an intra prediction unit 254, wherein the inter prediction unit 244 may be identical in function to the inter prediction unit 144, and the intra prediction unit 254 may be identical in function to the intra prediction unit 154. The prediction unit 260 and the mode selection unit 262 are typically configured to perform the block prediction and/or obtain the predicted block 265 from the encoded data 171 only (without any further information about the original image 101) and to receive or obtain (explicitly or implicitly) the prediction parameters 143 or 153 and/or the information about the selected prediction mode, e.g., from the entropy decoding unit 204.

The decoder 200 is configured to output the decoded picture 231, e.g., via output 232, for presentation or viewing to a user.

Referring back to FIG. 1, the decoded picture 231 output from the decoder 200 may be post-processed in the post-processor 326. The resulting post-processed picture 327 may be transferred to an internal or external display device 328 and displayed.

### Details of Embodiments and Examples

According to the HEVC/H.265 standard, 35 intra prediction modes are available. This set contains the following modes: planar mode (the intra prediction mode index is 0), DC mode (the intra prediction mode index is 1), and directional (angular) modes that cover the 180° range and have the intra prediction mode index value range of 2 to 34. To capture the arbitrary edge directions present in natural video, the number of directional intra modes may be extended from 33, as used in HEVC, to 65. It is worth noting that the range that is covered by intra prediction modes can be wider than 180°. In particular, 62 directional modes with index values of 3 to 64 cover the range of approximately 230°, i.e., several pairs of modes have opposite directionality. In the case of the HEVC Reference Model (HM) and Joint Exploration Model (JEM) platforms, only one pair of angular modes (namely, modes 2 and 66) has opposite directionality. For constructing a predictor, conventional angular modes take reference samples and (if needed) filter them to get a sample predictor. The number of reference samples required for constructing a predictor depends on the length of the filter used for interpolation (e.g., bilinear and cubic filters have lengths of 2 and 4, respectively).

In order to take advantage of the availability of reference samples that are used at the stage of intra prediction, bidirectional intra prediction (BIP) is introduced. BIP is a mechanism of constructing a directional predictor by generating a prediction value in combination with two kinds of the intra prediction modes within each block. Distance-Weighted Direction Intra Prediction (DWDIP) is a particular implementation of BIP. DWDIP is a generalization of bidirectional intra prediction that uses two opposite reference samples for any direction. Generating a predictor by DWDIP includes the following two steps:

a) Initialization where secondary reference samples are generated; and

b) Generate a predictor using a distance-weighted mechanism.

Both primary and secondary reference samples can be used in step b). Samples within the predictor are calculated as a weighted sum of reference samples defined by the selected prediction direction and placed on opposite sides. Prediction of a block may include steps of generating secondary reference samples that are located on the sides of the block that are not yet reconstructed and to be predicted, i.e., unknown samples. Values of these secondary reference samples are derived from the primary reference samples, which are obtained from the samples of the previously reconstructed part of the picture, i.e., known samples. That means primary reference samples are taken from adjacent reconstructed blocks. Secondary reference samples are generated using primary reference samples. Pixels/samples are predicted using a distance-weighted mechanism.

If DWDIP is enabled, a bi-directional prediction is involved using either two primary reference samples (when both corresponding references belong to available neighbor blocks) or primary and secondary reference samples (otherwise, when one of the references belongs to neighboring blocks that are not available).

FIG. 4 illustrates an example of the process of obtaining predicted sample values using the distance-weighting procedure. The predicted block is adaptable to the difference between the primary and secondary reference samples (pᵣₛ₁−pᵣₛ₀) along a selected direction, where pᵣₛ₀ represents a value of the primary reference pixels/sample; pᵣₛ₁ represent a value of the secondary reference pixels/samples.

In FIG. 4, a prediction sample could be calculated directly, i.e.:

p[i,j]=pᵣₛ₀·wₚᵣᵢₘ+pᵣₛ₁·w_{sec}=pᵣₛ₀·wₚᵣᵢₘ+pᵣₛ₁·(1−wₚᵣᵢₘ,

wₚᵣᵢₘ+w_{sec}=1.

Secondary reference samples pᵣₛ₁ are calculated as a weighted sum of linear interpolation between two corner-positioned primary reference samples (p_{grad}) and directional interpolation from primary reference samples using selected intra prediction mode (pᵣₛ₀):

pᵣₛ₁=pᵣₛ₀·wᵢₙₜₑᵣₚ+p_{grad}·w_{grad}=pᵣₛ₀·wᵢₙₜₑᵣₚ+p_{grad}·(1−wᵢₙₜₑᵣₚ),

wᵢₙₜₑᵣₚ+w_{grad}=1.

Combination of these equations gives the following:

p[i,j]=pᵣₛ₀·wₚᵣᵢₘ+(pᵣₛ₀·wᵢₙₜₑᵣₚ+p_{grad}·(1−wᵢₙₜₑᵣₚ))·(1−wₚᵣᵢₘ),

p[i,j]=pᵣₛ₀·wₚᵣᵢₘ+pᵣₛ₀·wᵢₙₜₑᵣₚ+p_{grad}·(1−wᵢₙₜₑᵣₚ)−pᵣₛ₀·wₚᵣᵢₘ·wᵢₙₜₑᵣₚ−p_{grad}·(1−wᵢₙₜₑᵣₚ)·wₚᵣᵢₘ,

p[i,j]=pᵣₛ₀·(wₚᵣᵢₘ−wₚᵣᵢₘ·wᵢₙₜₑᵣₚ+wᵢₙₜₑᵣₚ)+p_{grad}·(1−wᵢₙₜₑᵣₚ)−p_{grad}·(1−wᵢₙₜₑᵣₚ)·wₚᵣᵢₘ,

p[i,j]=pᵣₛ₀·(wₚᵣᵢₘ−wₚᵣᵢₘ·wᵢₙₜₑᵣₚ+wᵢₙₜₑᵣₚ)+p_{grad}·(1−wᵢₙₜₑᵣₚ−wₚᵣᵢₘ+wᵢₙₜₑᵣₚ·wₚᵣᵢₘ).

The latter equation could be simplified by denoting w=1−wₚᵣᵢₘ+wₚᵣᵢₘ·wᵢₙₜₑᵣₚ−wᵢₙₜₑᵣₚ, in specific:

p[i,j]=pᵣₛ₀·(1−w)+p_{grad}·w.

Thus, a pixel value predicted using DWDIP is calculated as follows:

p[i,j]=pᵣₛ₀+w·(p_{grad}−pᵣₛ₀)

Herein, variables i and j are column/row indices corresponding to x and y used in FIG. 4. The weight w(i,j)=dᵣₛ₀/D representing the distance ratio is derived from tabulated values wherein dᵣₛ₀ represents the distance from a predicted sample to a corresponding primary reference sample, D represents the distance from the primary reference sample to the secondary reference sample. In the case when primary and secondary reference samples are used, this weight compensates for directional interpolation from primary reference samples using selected intra prediction mode so that pᵣₛ₁ comprises only the linearly interpolated part. Consequently, pᵣₛ₁=p_{grad}, and therefore:

p[x,y]=pᵣₛ₀+w·(pᵣₛ₁−pᵣₛ₀).

Significant computational complexity is required for calculating the weighting coefficients w(ij) that depend on the position of a pixel within a block to be predicted, i.e., the distances to both reference sides (block boundaries) along the selected direction. To simplify the calculations, straightforward calculation of the distances is replaced by implicit estimations of distances using the column or/and row indices of the pixel. As proposed in US patent application US 2014/0092980 A1 “Method and apparatus of directional intra prediction”, the weighting coefficient values selected according to the prediction direction and the column index j of the current pixel for slant horizontal prediction directions.

In examples of DWDIP, piecewise linear approximation has been used that allows to achieve sufficiently high accuracy without too high computational complexity that is crucial for intra prediction techniques. Details on the approximation process will be given below.

It is further noted that for vertical direction of intra prediction, the weighting coefficient w=dᵣₛ₀/D will have the same value for all the columns of a row, i.e., it will not depend on the column index i.

FIG. 5 illustrates an example of vertical intra prediction. In FIG. 5, circles represent centers of samples' positions. Specifically, the cross-hatched ones 510 marks the positions of primary reference samples, the diagonally hatched ones 610 marks the positions of secondary reference samples, and the open ones 530 represent positions of the predicted pixels. The term “sample” in this disclosure is used to include but not limited to sample, pixel, sub-pixel, etc. For vertical prediction, the coefficient w changes gradually from the topmost row to the bottommost row with the step:

$${w}_{row} = \frac{1}{D} \approx \frac{{2}^{10}}{H + 1} ,$$

In this expression, D is the distance between the primary reference pixels/samples and the secondary reference pixels/samples; H is the height of a block in pixels, 2¹⁰ is a precision degree of an integer representation of the weighting coefficient row step wo.

For the case of vertical intra prediction modes, a predicted pixel value is calculated as follows:

p[x,y]=pᵣₛ₀+(w_{y}·(pᵣₛ₁−pᵣₛ₀)>>10)=pᵣₛ₀+(y·Δw_{row}·(pᵣₛ₁−pᵣₛ₀)>>10)

where pᵣₛ₀ represents a value of the primary reference pixels/sample; pᵣₛ₁ represent a value of the secondary reference pixels/samples, [x,y] represents a location of the predicted pixel, w_{y} represents a weighting coefficient for the given row y. The sign “>>” means “bitwise right shift”.

FIG. 6 is an example of skew-directional intra prediction. Skew modes include a set of angular intra-prediction modes excluding horizontal and vertical ones. Skew-directional intra prediction modes partially use a similar mechanism of weighting coefficient calculation. The value of the weighting coefficient will remain the same, but only within a range of columns. This range is defined by two lines 500 that cross the top-left and bottom-right corners of the bounding rectangle (see FIG. 6) and have the slope as specified by the pair (dx,dy) of the intra prediction mode being used.

These skew lines split the bounding rectangle of predicted block into three regions: two equal triangles (A, C) and one parallelogram (B). Samples having positions within the parallelogram will be predicted using weights from the equation for vertical intra-prediction, which, as explained above with reference to FIG. 5, are independent from the column index (i). Prediction of the rest of the samples is performed using weighting coefficients that change gradually along with the column index. For a given row, weight depends on the position of the sample, as is shown in FIG. 7. A skew line is a line excluding vertical and horizontal ones. In other words, a skew line is a non-vertical line or a non-horizontal line.

A weighting coefficient for a sample of a first row within the parallelogram is the same as a weighting coefficient for another sample of the first row within the parallelogram. The row coefficient difference Δw_{row} is a difference between the weighting coefficient for the first row and a weighting coefficient for a second row within the parallelogram, wherein the first row and the second row are neighboring within the parallelogram.

FIG. 7 is an illustration of the dependence of the weighting coefficient on the column index for a given row. Left and right sides within the parallelogram are denoted as x_{left} and x_{right}, respectively. The step of the weighting coefficient change within a triangular shape is denoted as Δwₜᵣᵢ·Δwₜᵣᵢ is also referred to as a weighting coefficient difference between a weighting coefficient of a sample and a weighting coefficient of its neighbor sample. As shown in FIG. 7, a first weighting coefficient difference for a first sample within the triangle region is Δwₜᵣᵢ, and a second weighting coefficient difference for a second sample within the triangle region is also Δwₜᵣᵢ. Different weighting coefficient differences have a same value Δwₜᵣᵢ in the example of FIG. 8. The sample and its neighbor sample are within a same row in this example of FIG. 8. This weighting coefficient difference Δwₜᵣᵢ is obtained based on the row coefficient difference and an angle α of the intra prediction. As an example, Δwₜᵣᵢ may be obtained as follows:

$$Δ {w}_{tri} = Δ {w}_{row} \frac{sin 2 α}{2} .$$

The angle of the prediction α is defined as

$$α = arctan \frac{dy}{d x} .$$

The implementation uses tabulated values per each intra prediction mode:

$${K}_{tri} = round ( \frac{{2}^{10}}{2} sin 2 α ) = round ( 512 \cdot sin 2 α ) .$$

### Hence,

Δwₜᵣᵢ=(KₜᵣᵢΔw_{row}+(1<<4))>>5

where “<<” and “>>” are left and right binary shift operators, respectively.

After the weighting coefficient difference Δwₜᵣᵢ is obtained, a weighting coefficient w(i,j) may be obtained based on Δwₜᵣᵢ. Once the weighting coefficient w(i,j) is derived, a pixel value p[x, y] may be calculated based on w(i, j).

FIG. 7 is an example. As another example, the dependence of a weighting coefficient on the row index for a given column may be provided. Here, Δwₜᵣᵢ is a weighting coefficient difference between a weighting coefficient of a sample and a weighting coefficient of its neighbor sample. The sample and its neighbor sample are within a same column.

Aspects of the above examples are described in the contribution document CE3.7.2 “Distance-Weighted Directional Intra Prediction (DWDIP)”, by A. Filippov, V. Rufitskiy, and J. Chen, Contribution JVET-K0045 to the 11th meeting of the Joint Video Experts Team (JVET) of ITU-T SG 16 WP 3 and ISO/EC JTC I/SC 29WG 11, Ljubljana, Slovenia, July 2018. http://phenix.it-sudparis.eu/jvet/doc_end_user/documents/11_Ljubljana/wg11/JVET-K0045-v2.zip.

FIG. 8 illustrates the weights associated with second the reference samples for a block having a width equal to 8 samples and a height equal to 32 samples in the case when an intra-prediction direction is diagonal, and the prediction angle is 45° relating to the top-left corner of the block. Here, the darkest tone corresponds to lower weight, and the brighter tone corresponds to greater weight values. Weight minimum and maximum are located along the left and right sides of the block, respectively.

In the above examples, using intra prediction based on a weighted sum of appropriate primary and secondary reference sample values, still complicated calculations are necessary already for the generation of the secondary reference sample values by interpolation.

On the other hand, since the secondary reference sample values, pᵣₛ₁ comprise only the linearly interpolated part, the usage of interpolation (especially a multi-tapped one) and weighting is redundant. Samples predicted just from pᵣₛ₁ also change gradually. Thus, it is possible to calculate the values of the increments in the vertical and horizontal direction without explicit calculation of pᵣₛ₁ using just primary reference samples located in the reconstructed neighboring blocks near the top-right (p_{TR}) and the bottom-left (p_{BL}) corners of the block to be predicted.

The present disclosure proposes to calculate an increment value for a given position (X, Y) within a block to be predicted and to apply the corresponding increment just after interpolation from the primary reference samples is complete.

In other words, the present disclosure completely avoids the need to calculate secondary reference samples involving interpolation and instead generates predictions of pixel values in the current block by adding increment values that depend at least on the position of a predicted pixel in the current block. In particular, this may involve repetitively additional operations in an iterative loop. Details of embodiments will be described in the following with reference to FIGS. 9 to 11.

Two variants of the overall processing flow for deprivation of prediction samples according to embodiments of the present invention are illustrated in FIGS. 9A and 9B. These variants differ from each other by the input to the step of computing increments for the gradual component. The processing in FIG. 9A uses unfiltered neighboring samples, whereas FIG. 9B uses filtered ones.

More specifically, according to the processing illustrated in FIG. 9A, the reference sample values (summarized here as Sₚ) undergo reference sample filtering in step 900. As indicated above, this step is optional. In embodiments of the invention, this step may be omitted, and the neighboring “primary” reference sample values can be directly used for the following step 910. In step 910, the preliminary prediction of the pixel values is calculated based on the (optionally filtered) reference sample values from the reconstructed neighboring blocks, Sₚ. This process, as well as the optional filtering process, is not modified as compared to the respective conventional processing. In particular, such processing steps are well known from existing video coding standards (for example, H.264, HEVC, etc.). The result of this processing is summarized as Ser here.

In parallel, the known reference sample values from the neighboring block are used to compute gradual increment components in step 920. The calculated gradual increment component values, Δgₓ and Δg_{y}, may, in particular, represent “partial increments” to be used in an iterative procedure that will be illustrated in more detail below with reference to FIGS. 10 and 11.

In accordance with exemplary embodiments described herein, the values Δgₓ and Δg_{y} may be calculated as follows: For a block to be predicted having tbW samples in width and tbH samples in height, increments of gradual components could be computed using the following equations:

$$Δ {g}_{x} = 2 \frac{{p}_{TR} - {p}_{BL}}{{tbW}^{2}} , \\ Δ {g}_{y} = 2 \frac{{p}_{BL} - {p}_{TR}}{{tbH}^{2}} .$$

As indicated above, p_{BL} and p_{TR} represent (“primary”) reference sample values at positions near the top right and bottom left corner of the current block (but within reconstructed neighboring blocks). Such positions are indicated in FIG. 5.

Consequently, the increment values according to an embodiment of the present invention depend only on two fixed reference sample values from available, i.e., known (reconstructed) neighboring blocks, as well as the size parameters (width and height) of the current block. They do not depend on any further “primary” reference sample values.

In the following step 930, the (final) prediction sample values are calculated on the basis of both the preliminary prediction sample values and the computed increment values. This step will be detailed below with reference to FIGS. 10 and 11.

The alternative processing illustrated in FIG. 9B differs from the processing in FIG. 9A in that the partial increment values are created based on filtered reference sample values. Therefore, the respective step has been designated with a different reference numeral, 920′. Similarly, the final step of derivation of the (final) prediction samples, which is based on the increment value is determined in step 920′, has been given reference numeral 930′ so as to be distinguished from the respective step in FIG. 9B.

A possible process for deriving the prediction samples in accordance with embodiments of the present invention is shown in FIG. 10.

In accordance therewith, an iterative procedure for generating the final prediction values for the sample at the positions (x, y) is explained.

The flow of processing starts in step 1000, wherein initial values of the increment are provided. This is the above-defined values Δgₓ and Δg_{y} are taken as the initial values for the increment calculation.

In the following step 1010, the sum thereof is formed, designated as parameter g_{row}.

Step 1020 is the starting step of a first (“outer”) iteration loop, which is performed for each (integer) sample position in the height direction, i.e., according to the “y”-axis in accordance with the convention adopted in the present disclosure.

In the present disclosure, the convention is used, according to which a denotation as

for x∈[x₀,x₁)

indicates that the value of x is being incremented by 1, starting from x₀ and ending with x₁. Type of bracket denotes whether a range boundary value is in or it is out of the loop range. Rectangular brackets “[” and “]” mean that a corresponding range boundary value is in the loop range and should be processed within this loop. Parentheses “(” and “)” denote, that a corresponding range boundary value is out of the scope and should be skipped when iterating over the specified range. The same applies mutatis mutandis to other denotations of this type.

In the following step 1030, the increment value, g, is initialized with the value grow.

Subsequent step 1040 is the starting step of a second (“inner”) iteration loop, which is performed for each (integer) sample position in the width direction, i.e. according to the “x”-axis in accordance with the convention adopted in the present disclosure.

The following step 1050, the derivation of the preliminary prediction samples is performed, based on available (“primary”) reference sample values only. As indicated above, this is done in a conventional manner, and a detailed description thereof is therefore omitted here. This step thus corresponds to step 910 of FIG. 9.

The increment value g is added to the preliminary prediction sample value, designated as predSamples [x,y] herein, in the following step 1060.

In subsequent step 1070, the increment value is increased by the partial increment value Δgₓ and used as the input to the next iteration along the x-axis, i.e., in the width direction. In a similar manner, after all, sample positions in the width direction have been processed in the described manner, parameter g_{row} is increased by the partial increment value g_{y} in step 1080.

Thereby it is guaranteed that in each iteration, i.e., for each change of the sample position to be predicted by one integer value in the vertical (y) or the horizontal (x) direction, the same value is added to the increment. The overall increment thus linearly depends on the vertical as well as on the horizontal distance from the borders (x=0 and y=0, respectively).

In accordance with alternative implementations, the present disclosure may also consider the block shape and the intra-prediction direction, by subdividing a current block into regions in the same manner as illustrated above with reference to FIGS. 6 and 7. An example of such a processing is illustrated in FIG. 11.

Here, it is assumed that the block is subdivided into three regions, as illustrated in FIG. 6, by two skewed lines 500. Because the intersecting positions of the dividing skew lines 500 with the pixel rows, x_{left}, and x_{right}, are generally fractional, they have a subpixel precision “prec”. In practical implementation, prec is 2^{k}, with a car being a natural number (positive integer). In the flowchart of FIG. 11, fractional values x_{left} and x_{right} are approximated by integer values p_{left} and p_{right} as follows:

$${p}_{left} = ⌈ \frac{{x}_{left}}{prec} ⌉ , {p}_{right} = ⌈ \frac{{x}_{right}}{prec} ⌉ .$$

In the flowchart, a row of predicted samples is processed by splitting it into three regions, i.e., the triangular region A on the left, the parallelogram region B in the middle, and the triangular region C on the right. This processing corresponds to the three parallel branches illustrated in the lower portion of FIG. 11, each including an “inner” loop. More specifically, the branch on the left-hand side, running from x=0 to p_{left}, corresponds to the left-hand region, A of FIG. 6. The branch on the right-hand side, running from p_{left} to p_{right} corresponds to the processing in the middle region, B. The branch in the middle, running over x-values from from p_{right} to tbW corresponds to the processing in the right region, C. As will be seen below, each of these regions uses its own precomputed increment values.

For this purpose, in the initialization step 1100, besides Δgₓ and Δg_{y}, a further value, Δg_{x_tri} is initialized.

The value of Δg_{x_tri} is obtained from Δgₓ using angle of intra prediction α:

$$Δ {g}_{x \_ tri} = Δ {g}_{x} \frac{sin ( 2 α )}{2} .$$

To avoid floating-point operations, and sine function calculations, a lookup table could be utilized. It could be illustrated by the following example that assumes the following:
Intra prediction mode indices are mapped to prediction direction angles as defined in VVC/BMS software for the case of 65 directional intra prediction modes.
sin 2a_half lookup table is defined as follows:
   sin 2a_half[16]={512, 510, 502, 490, 473, 452, 426, 396, 362, 325, 284, 241, 196, 149, 100, 50, 0}:
   For the above-mentioned assumptions, Δg_{x_tri} could be derived as follows:

Δg_{x_tri}=sign(Δ_{α})·((Δgₓ sin 2a_half[|Δ_{α}|]+512)>>10).

In this equation Δ_{α} is the difference between directional intra prediction mode index and either the index of vertical mode or the index of horizontal mode. Decision on what mode is used in this difference depends on whether mains prediction side is a top row of primary reference samples, or it is a left column of primary reference samples. In the first case Δ_{α}=m_{α}−m_{VER}, and in the second case Δ_{α}=m_{HOR}−m_{α}.
m_{α} is the index of intra prediction mode selected for the block being predicted. m_{VER}, m_{HOR} are indices of vertical and horizontal intra-prediction modes, respectively.

In the flowchart, parameter grow is initialized and incremented in the same manner as in the flowchart of FIG. 10. Also, the processing in the “outer” loop, in the height (y) direction, is the same as in FIG. 10. The respective processing steps 1010, 1020, and 1080 have therefore been designated with the same reference numerals as in FIG. 10, and repetition of the description thereof is herein omitted.

A difference between the processing in the “inner” loop, in the width (x) direction firstly resides in that each of the loop versions indicated in parallel is only performed within the respective region. This is indicated by the respective intervals in the starting steps 1140, 1145, and 1147.

Moreover, the actual increment value, g, is defined “locally”. This means that the modification of the value in one of the branches does not affect the respective values of the variable g used in the other branches.

This can be seen from the respective initial steps, before the loop starts, as well as from the final steps of the initial loops, wherein the variable value g is incremented. In the right-hand side branch, which is used in the parallelogram region B, the respective processing is performed in the same manner as in FIG. 10. Therefore, the respective reference numerals 1030, 1050, 1060, and 1070 indicating the steps remain unchanged.

In the left-hand and the middle branch for the two triangular regions, the initialization step of parameter g is different. Namely, it takes into account the angle of the intra-prediction direction, by means of the parameter Δg_{x_tri} that was introduced above. This is indicated by the formulae in the respective steps 1130 and 1135 in FIG. 11. Consequently, in these two branches, step 1070 of incrementing the value g is replaced with step 1170, wherein the parameter g is incremented by Δg_{x_tri} for each iteration. The rest of the steps, 1050 and 1060, is again the same as this has been described above with respect to FIG. 10.

Implementations of the subject matter and the operations described in this disclosure may be implemented in digital electronic circuitry, or in computer software, firmware, or hardware, including the structures, disclosed in this disclosure and their structural equivalents, or in combinations of one or more of them. Implementations of the subject matter described in this disclosure may be implemented as one or more computer programs, i.e., one or more modules of computer program instructions, encoded on computer storage medium for execution by, or to control the operation of, data processing apparatus. Alternatively or in addition, the program instructions may be encoded on an artificially-generated propagated signal, for example, a machine-generated electrical, optical, or electromagnetic signal that is generated to encode information for transmission to suitable receiver apparatus for execution by a data processing apparatus. A computer storage medium, for example, the computer-readable medium, may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical and/or non-transitory components or media (for example, multiple CDs, disks, or other storage devices).

It is emphasized that the above particular examples are given for illustration only, and the present disclosure as defined by the appended claims is by no means limited to these examples. For instance, in accordance with embodiments, the processing could be performed analogously, when the horizontal and vertical directions are exchanged, i.e., the “outer” loop is performed along the x direction, and the “inner” loop is performed along the y direction. Further modifications are possible within the scope of the appended claims.

In summary, the present disclosure relates to an improvement of known bidirectional inter-prediction methods. According to the present disclosure, instead of interpolation from secondary reference samples, for calculating samples in intra prediction, calculation based on “primary” reference sample values only is used. The result is then refined by adding an increment which depends at least on the position of the pixel (sample) within the current block and may further depend on the shape and size of the block and the prediction direction but does not depend on any additional “secondary” reference sample values. The processing, according to the present disclosure, is thus less computationally complex because it uses a single interpolation procedure rather than doing it twice: for primary and secondary reference samples.

Note that this specification provides explanations for pictures (frames), but fields substitute as pictures in the case of an interlace picture signal.

Although embodiments of the invention have been primarily described based on video coding, it should be noted that embodiments of the encoder 100 and decoder 200 (and correspondingly the system 300) may also be configured for still picture processing or coding, i.e., the processing or coding of an individual picture independent of any preceding or consecutive picture as in video coding. In general only inter-estimation 142, inter-prediction 144, 242 are not available in case the picture processing coding is limited to a single picture 101. Most if not all other functionalities (also referred to as tools or technologies) of the video encoder 100 and video decoder 200 may equally be used for still pictures, e.g., partitioning, transformation (scaling) 106, quantization 108, inverse quantization 110, inverse transformation 112, intra-estimation 142, intra-prediction 154, 254 and/or loop filtering 120, 220, and entropy coding 170 and entropy decoding 204.

Wherever embodiments and the description refer to the term “memory”, the term “memory” shall be understood and/or shall comprise a magnetic disk, an optical disc, a solid-state drive (SSD), a read-only memory (Read-Only Memory, ROM), a random access memory (Random Access Memory, RAM), a USB flash drive, or any other suitable kind of memory, unless explicitly stated otherwise.

Wherever embodiments and the description refer to the term “network”, the term “network” shall be understood and/or shall comprise any kind of wireless or wired network, such as Local Area Network (LAN), Wireless LAN (WLAN) Wide Area Network (WAN), an Ethernet, the internet, mobile networks, etc., unless explicitly stated otherwise.

The person skilled in the art will understand that the “blocks” (“units” or “modules”) of the various figures (method and apparatus) represent or describe functionalities of embodiments of the invention (rather than necessarily individual “units” in hardware or software) and thus describe equally functions or features of apparatus embodiments as well as method embodiments (unit=step).

The terminology of “units” is merely used for illustrative purposes of the functionality of embodiments of the encoder/decoder and are not intended to limit the disclosure.

In the several embodiments provided in the present application, it should be understood that the disclosed system, apparatus, and method may be implemented in other manners. For example, the described apparatus embodiment is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

Embodiments of the invention may further comprise an apparatus, e.g., encoder and/or decoder, which comprises a processing circuitry configured to perform any of the methods and/or processes described herein.

Embodiments of the encoder 100 and/or decoder 200 may be implemented as hardware, firmware, software, or any combination thereof. For example, the functionality of the encoder/encoding or decoder/decoding may be performed by a processing circuitry with or without firmware or software, e.g., a processor, a microcontroller, a digital signal processor (DSP), a field-programmable gate array (FPGA), an application-specific integrated circuit (ASIC), or the like.

The functionality of the encoder 100 (and corresponding encoding method 100) and/or decoder 200 (and corresponding decoding method 200) may be implemented by program instructions stored on a computer-readable medium. The program instructions, when executed, cause a processing circuitry, computer, processor, or the like to perform the steps of the encoding and/or decoding methods. The computer-readable medium can be any medium, including non-transitory storage media, on which the program is stored, such as a Blu-ray disc, DVD, CD, USB (flash) drive, hard disc, server storage available via a network, etc.

An embodiment of the invention comprises or is a computer program comprising program code for performing any of the methods described herein when executed on a computer.

An embodiment of the invention comprises or is a computer-readable medium comprising a program code that, when executed by a processor, causes a computer system to perform any of the methods described herein.

An embodiment of the invention comprises or is a chipset performing any of the methods described herein.

1. An apparatus comprising:
at least one processor; and
a non-transitory computer-readable storage medium coupled to at least one processor and storing programming instructions for execution by the at least one processor, the programming instructions instructing the at least one processor to perform operations for intra prediction of a current block of a picture, the operations comprising:
calculating a preliminary prediction sample value of a sample of the current block based on reference sample values of reference samples located in reconstructed neighboring blocks of the current block of the picture; and
calculating a final prediction sample value of the sample by adding an increment value to the preliminary prediction sample value, wherein the increment value is based on a position of the sample in the current block.

2. The apparatus of claim 1, wherein:
(1) the reference samples are located in a row of samples directly above the current block and in a column of samples to a left side or to a right side of the current block, or
(2) the reference samples are located in a row of samples directly below the current block and in a column of samples to a left side or to a right side of the current block.

3. The apparatus of claim 1, wherein the preliminary prediction sample value is calculated according to a directional intra prediction of the sample of the current block.

4. The apparatus of claim 1, wherein the increment value is determined based on a number of samples of the current block in width and a number of samples of the current block in height.

5. The apparatus of claim 1, wherein the increment value is determined using two reference samples including a first reference sample and a second reference sample, wherein:
a first reference sample is located in a column that is to a right of a rightmost column of the current block, and
a second reference sample is located in a row that is below a lowest row of the current block.

6. The apparatus of claim 1, where the increment value is determined using a lookup table comprising values that each specify a partial increment of the increment value depending on an intra prediction mode index, wherein the lookup table provides a respective partial increment of the increment value for each intra prediction mode index.

7. The apparatus of claim 1, wherein the increment value depends linearly on a position within a row of predicted samples in the current block.

8. The apparatus of claim 1, wherein the increment value depends piecewise linearly on a position within a row of predicted samples in the current block.

9. The apparatus of claim 1, wherein the operations comprise:
using a directional mode for calculating the preliminary prediction sample value based on a directional intra prediction.

10. The apparatus of claim 1, wherein the increment value is determined based on at least one of a block shape or a prediction direction.

11. The apparatus of claim 1, wherein the increment value linearly depends on a first distance of the sample from a first block boundary in a vertical direction and linearly depends on a second distance of the sample from a second block boundary in a horizontal direction.

12. The apparatus of claim 1, wherein the operations comprise:
calculating the final prediction sample value of the sample by iteratively adding the increment value to the preliminary prediction sample value, wherein partial increments of the increment value are subsequently added to the preliminary prediction sample value.

13. The apparatus of claim 1, wherein the operations comprise: obtaining a predicted block for the current block based on the intra prediction of the current block of the picture, and
wherein the apparatus further comprises: processing circuitry configured to encode the current block based on the predicted block.

14. A method for intra prediction of a current block of a picture, the method comprising:
calculating a preliminary prediction sample value of a sample of the current block based on reference sample values of reference samples located in reconstructed neighboring blocks of the current block; and
calculating a final prediction sample value of the sample by adding an increment value to the preliminary prediction sample value, wherein the increment value is based on a position of the sample in the current block.

15. A non-transitory computer-readable storage medium coupled to at least one processor and storing programming instructions for execution by the at least one processor, wherein the programming instructions instruct the at least one processor to perform operations for intra prediction of a current block of a picture, the operations comprising:
calculating a preliminary prediction sample value of a sample of the current block based on reference sample values of reference samples located in reconstructed neighboring blocks of the current block; and
calculating a final prediction sample value of the sample by adding an increment value to the preliminary prediction sample value, wherein the increment value is based on a position of the sample in the current block.

16. The non-transitory computer-readable storage medium of claim 15, wherein:
(1) the reference samples are located in a row of samples directly above the current block and in a column of samples to a left side or to a right side of the current block, or
(2) the reference samples are located in a row of samples directly below the current block and in a column of samples to a left side or to a right side of the current block.

17. The non-transitory computer-readable storage medium of claim 15, wherein the preliminary prediction sample value is calculated according to directional intra prediction of the sample of the current block.

18. The non-transitory computer-readable storage medium of claim 15, wherein the increment value is determined based on a number of samples of the current block in width and a number of samples of the current block in height.

19. The non-transitory computer-readable storage medium of claim 15, wherein the increment value is determined using two reference samples comprising:
a first reference sample located in a column that is to a right of a rightmost column of the current block, and
a second reference sample located in a row that is below a lowest row of the current block.

20. The non-transitory computer-readable storage medium of claim 15, wherein the increment value is determined using a lookup table comprising values that each specify a partial increment of the increment value based on the intra prediction mode index, and
wherein the lookup table provides a respective partial increment of the increment value for each intra prediction mode index.
